(19) United States
(12) Patent Application Publication
(10) Pub. No.: US 2019/0027857 A1
(43) Pub. Date: Jan. 24, 2019

(54) ELECTRICAL PLUG CONNECTION

(71) Applicant: Voith Patent GmbH, Heidenheim (DE)

(72) Inventor: Markus Narberhaus, Hildesheim (DE)

(73) Assignee: Voith Patent GmbH, Heidenheim (DE)

(21) Appl. No.: 16/139,177

(22) Filed: Sep. 24, 2018

Related U.S. Application Data
(63) Continuation of application No. PCT/EP2017/057256, filed on Mar. 28, 2017.

(30) Foreign Application Priority Data
Apr. 5, 2016 (DE) 10 2016 205 586.0

(51) Int. Cl. H01R 13/512; H01R 13/6591; H01R 13/6589; B61G 5/10

(52) U.S. Cl. CPC H01R 13/512; H01R 13/6591; H01R 24/86; B61G 5/10; H01R 13/6589

(57) ABSTRACT

A plug connection for transmittal of electrical signals, including a housing; an insulating member to be arranged inside the housing and having a plurality of internally located conductors which are insulted from one another; wherein the insulating member includes an insulating member front part and an insulating member rear part; wherein the insulating front part can be connected mechanically to an insulating member front part of another plug connection and wherein the conductor of the insulating member rear part can be electrically connected to a cable. The conductors between the insulating member rear part and the insulating member front part in each case form a detachable electrical connection.

### CROSS REFERENCE TO RELATED APPLICATIONS

This is a continuation of PCT application No. PCT/EP2017/057256, entitled “ELECTRICAL PLUG CONNECTION”, filed Mar. 28, 2017, which is incorporated herein by reference.

### BACKGROUND OF THE INVENTION

### 1. Field of the Invention

The invention relates to an electrical plug connection, in particular between two vehicle parts. More precisely, the invention relates to a plug connection for transmittal of data.

### 2. Description of the Related Art

In the rail vehicle technology, electrocontact couplings are used for transmittal of signals or for power transfer between two adjacent railcar bodies of a multi-section vehicle, for example a train. The configuration and size of the used electrocontact couplings depend upon the available space in the vehicle, the number of signals that are to be transmitted and the demands on the vehicle manufacturer or respectively the train operator.

In such an electrocontact coupling, plug connections are generally provided for the electrical lines that are to be run from one train section to an adjacent train section. When coupling two train sections, the electrocontact couplings that are mounted on the train section are moved onto each other and aligned with each other in such a way that the plug connections engage and connect electrically with each other.

In transmission of electrical signals via the plug connections, an increase in the transmission rates and in the amount of data that is transmitted can be expected in the future. It is already common practice to route, in addition to pure control signals, a vehicle bus or signals for entertainment electronics via plug connections. Data bus connectors are herein used which achieve data rates up to 1 Gbps.

However, at higher data rates of above 1 Gbps the signal quality deteriorates with the data bus connectors available on today's market to such an extent that a practicable signal transmission is no longer possible.

### SUMMARY OF THE INVENTION

The present invention provides improved technology for the transmittal of electrical signals, in particular between two train sections that can be coupled with one another.

A plug connection for transmittal of electrical signals includes a housing; an insulating member to be arranged inside the housing and having a plurality of internally located conductors which are insulated from one another, wherein the insulating member includes an insulating member front part and an insulating member rear part; wherein the insulating member front part can be connected mechanically with an insulating member front part of another plug connection and wherein the conductors on the insulating member rear part can be electrically connected to a cable. The conductors between the insulating member rear part and the insulating member front part in each case form a detachable electrical connection.

The plug connection can be equipped with an additional structurally identical or complimentary plug connection for mechanical and/or electrical connection. The insulating member can individually mechanically fasten the conductors or can insulate them electrically from one another. The insulating member can for example be manufactured of a plastic, for instance by casting or injection molding. If the plug connection is used between two train sections, the insulating member can be subjected to increased mechanical wear on the side that is equipped to engage with the additional plug connection due to connection and detachment procedures. Or, if no additional plug connection is inserted, can be subjected to increased exposure to dirt. Because of the two-part construction of the insulating member, the insulating member front part can be easily replaced without having to disconnect the mechanical or electrical connection of a cable that is connected with the rear part of the insulating member. The accessibility to the front part of the insulating member from the plug side is generally very good, so that replacement process can be quickly and easily accomplished.

A conductor that is accommodated in the front part of the insulating member can form an electrical connection with a conductor that is accommodated in the rear part of the insulating member in that the two conductors are located essentially axially adjacent to another. In order to increase the contact reliability, at least one of the insulating members can be designed to be elastic. In another embodiment, the electrical connection between the two conductors can be established by a non-axial contact element. An electrical and mechanical contact between the conductors can herein be established by mutual contact in non-axial direction, in other words in radial or tangential direction relative to a longitudinal axis of the plug connection. For example, one of the conductors could include a pin and the other a sleeve or a tube that can be fitted together. The mutual contact of the conductors can herein act in particular perpendicular to the axial direction, for example as tension force of the tube or of a lateral elastic contact tab at the tube or on the pin.

In another embodiment, the housing can include a housing rear part and a housing front part that is detachable from same, wherein the insulating member front part can be removed from the insulating member rear part when the housing front part is separated from the housing rear part. The housing front part can lock the insulating member front part in the housing. The maintainability of the insulating member front part can herein be further increased. The housing front part which, in itself can be subject to great mechanical stresses may be replaceable separately. In one embodiment, the housing front part and the insulating front part are provided as an integrated separately manageable unit so that, in an improvement they can be replaced together.

In another embodiment the housing rear part is equipped to be inserted into a stepped bore, wherein the plug connection moreover includes a screw element that is equipped with a thread to provide a screw connection with the stepped bore in order to press the housing front part axially against the housing rear part. The stepped bore includes at least a smaller bore, a larger bore and a radial step between the bores. The cable can be routed through the smaller bore. The thread can be provided as an inside thread on the greater diameter, wherein the screw element includes an outside thread. In another embodiment an outside thread is included in the region of the stepped bore and the screw element is designed according to a nut, for example a cap nut with an inside thread. In both cases the screw element may have an axial recess through which a section of the plug connection or of the other plug connection can extend. The screw element can be turned by a special wrench. It may in particular have face holes for use with a spanner wrench

In another embodiment the housing may be a full metal housing so that it can provide a shielding function. For this purpose, it may in particular be conductively combined with an additional element of the plug connection that is used for shielding, for example a contact lamella.

The insulating member front part and the insulating member rear part respectively can include an electrically conductive shielding element which shields a first group of conductors from a second group of conductors, and wherein shielding elements of the insulating member front part and the insulating member rear part together form a detachable electrical connection. Thus, the groups of conductors can be shielded from one another in the region of the insulating member. The groups can thus be better shielded in a radial direction in regard to field density, in particular in combination with an additional shield that is located radially outside of the conductors, for example in the embodiment of a conductive housing.

Several shielding elements can be provided on the insulating member front part or the insulator rear part which are equipped to respectively shield pairs of conductors from each other. In one embodiment, the shielding elements cross each other along an axial interface so that, when viewed in axial direction, the shielding elements form an X-shaped structure of four quadrants where one group of conductors is located. Each group can include two conductors, so that in total eight conductors in pairs of two conductors each are shielded from each other.

The insulating member rear part can include a plug, on its side facing away from the insulating member front part, for contact with the plurality of conductors that are routed inside the insulating member. The plug can in particular include an X-coded connector plug that may be equipped with a M12-plug connection or screw connection.

An automatic electrical coupling device for installation in a rail-based vehicle includes at least one plug connection as described herein. A connection or disconnect process of the plug connection can occur like a coupling or decoupling process between two rail-based vehicles or vehicle parts through relative, essentially axial movement. Opening and closing of the plug connection of the coupling device can thus be implemented automated parallel to coupling or decoupling of the vehicle parts.

The coupling device can include a contact support with a recess in which the plug connection is accommodated, at least over a section of its extension in longitudinal direction. The contact support can be mounted in particular on a coupling device for mechanical coupling of vehicles or can be included in same. The contact support can also include an equipment element between the vehicles.

The coupling device may include several plug connections which can be arranged in particular so that the vehicle is maneuverable. One or several plug connections can be redundant and can be designed complimentary on the coupling device. The plug connections can thus be arranged left and right of a center axis of the track-guided vehicle, so that the vehicle is maneuverable. For example, a male and a female plug connection can be arranged on opposite sides of a center axis of a first vehicle. Expressed in other words, a first vehicle can be coupled with its front side or its rear side with the same side of a second vehicle. Several plug connections are respectively provided and mounted in such a way on the front and rear side of the first vehicle so that an electrical connection can be produced as a result of the front-side or rear-side coupling with the second vehicle. A data connection can be produced via the electrical connection.

A data bus connector providing a data connection between two vehicles for transmission of data at a data rate of higher than 1 Gbps can generally include a housing and an insulating member arranged inside the housing having a multitude or respectively a plurality of internally located conductors that are insulated from one another. The conductors can for example also be embedded in the insulating member and as a result be insulated from one another. The insulating member includes an insulating member rear part and an insulating member front part that can be connected electrically and mechanically with the insulating member rear part, wherein the insulating member rear part can be connected to a data cable and wherein the insulating member front part can be connected with an insulating member front part of another data bus connector. Here, the insulating front part can for example be designed with a first data bus connector of the male variety and with a second data bus connector of the female variety. A portion of the plurality of conductors located internally in the insulating body can be shielded from other conductors of the plurality of conductors. The data carrying conductors inside the insulating member can for example be shielded from each other in pairs. Hence, not only is a shielding provided toward the outside encompassing the plurality of electrical conductors, but individual conductor pairs are provided with shielding, so that for example undesirable crosstalk, in other words interference of signals of one conductor pair into another conductor pair, can be clearly reduced, thereby improving the signal quality in such a way that the desirable data rates of 10 Gbps and above can be attained. The shielding in one embodiment can be in the form of a separation of individual regions of the insulating member, so that for example always two conductor pairs are located in such a shielded region.

The shielding on the data bus connector can extend continuously through the entire data bus connector, in order to achieve high signal quality. In particular in the case of a two-part construction of the insulating member, insulating member front part and insulating member rear part, it is advantageous if the shielding between the two parts is provided for example by contact lamellas or something similar. In one embodiment the number of conductors may specifically be eight, resulting in four conductor pairs which respectively are shielded from one another. For simplification of assembly the insulating member rear part can be equipped on its side facing away from the insulating member front part with a plug for contact with the plurality of conductors that are routed inside the insulating member. The aforementioned plug may for example be an X-coded connector plug (male or female) of an M12-plug or screw connection, serving to connect the incoming line. With a plug of this type the mechanical work for connecting the line during assembly is eliminated. The housing can be a full metal housing, for example with a plated surface. The housing thus already provides shielding toward the outside. The outer shielding can also be combined with the interior shielding between the conductor pairs. The housing can be connected mechanically with an electrocontact coupling. The connection can for example be designed as a screw connection. The housing can moreover possess a contact lamella for electrical shield connectivity. The contact lamella can be equipped to produce an electrical contact, in particular in lateral or respectively radial direction and may be elastically in this direction. A shielding provided from the outside can thus be easily transferred into the housing.

An automatic electrical coupling device for a rail-based vehicle includes at least two data bus connectors as described herein. The automatic electrical coupling device can include a contact support with a multitude of recesses in which the data bus connectors are accommodated, at least over a section of their extension in longitudinal direction. The data bus connectors on the automatic electrical coupling can be arranged in such a manner that the vehicle is maneuverable.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic illustration of one application example of a data bus connector in an electrocontact coupling on rail vehicles;

FIG. 2 shows a partially sectionalized illustration of a simplified design example of a data bus connector pair;

FIG. 3 shows a perspective exploded view of a design example of a data bus connector; and

FIG. 4 shows views of an exemplary connector for connection of a cable with a data bus connector according to one of the FIG. 2 or 3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

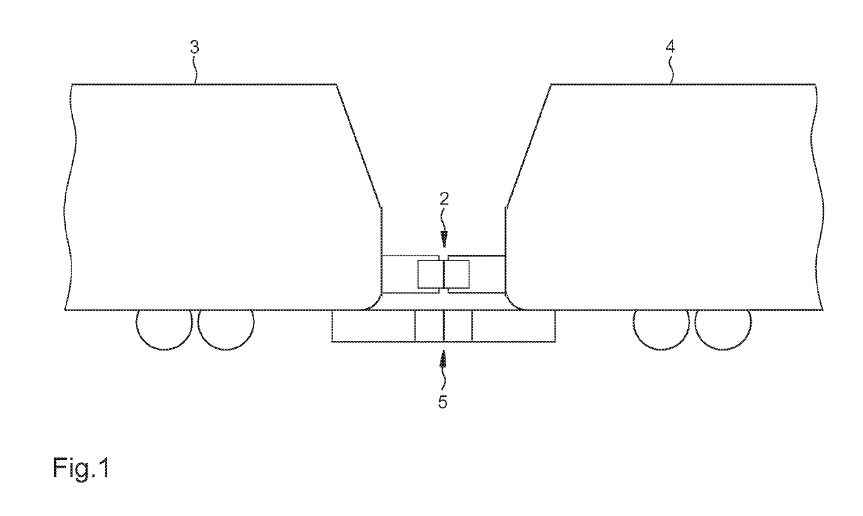

Referring to the drawings and more particularly to FIG. 1 there is shown an electrocontact coupling 2 on a partially illustrated rail vehicle 3, 4. Electrocontact coupling 2 produces an electrical connection between train parts 3, 4 so that signals and also electrical power are transferable. In addition, a mechanical train coupling 5 is illustrated by which train parts 3, 4 are mechanically connected.

In electrocontact coupling 2, a high efficiency data bus connector 10, 10′ is integrated for data transfer according to 10 Gb ethernet, for example into a high efficiency ethernet network, especially in the railway field for rail-based vehicles.

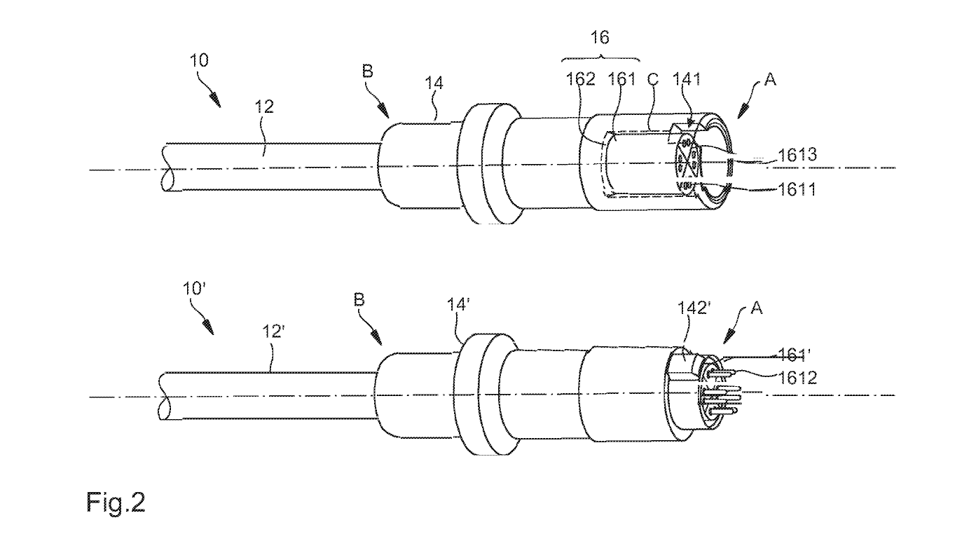

FIG. 2 shows simplified design examples of an electrocontact coupling 2. A longitudinal axis is indicated by a dash/dot line. The upper section of the illustration shows a female connector 10, the lower section a male connector 10′. A female connector 10 can generally also be generally referred to as socket 10. Below, the female design form of socket 10 is addressed first. Identical or comparable characteristics in the male design form 10′ are marked with the same identification marking, with an apostrophe and in order to avoid repetition, are not discussed separately.

Data bus connector 10 can be partitioned in longitudinal direction into a connector side A and a connection side B. A data cable 12 is brought to connection side B and is connected to connector 10. Data cable 12 may be based on electrical conductors instead of on light conductors and fulfills a specification that is necessary for transmittal of data of a data rate of up to approximately 10 Gbps, especially in accordance with an ethernet standard of 10 GbE or 10 GE. Possible transmittal techniques are described for example in IEEE 802.3ak or IEEE 802.3an. Data cable 12 may for example include a four-pair, shielded, symmetrical copper cable designed in accordance with Cat-6 or Cat-6A.

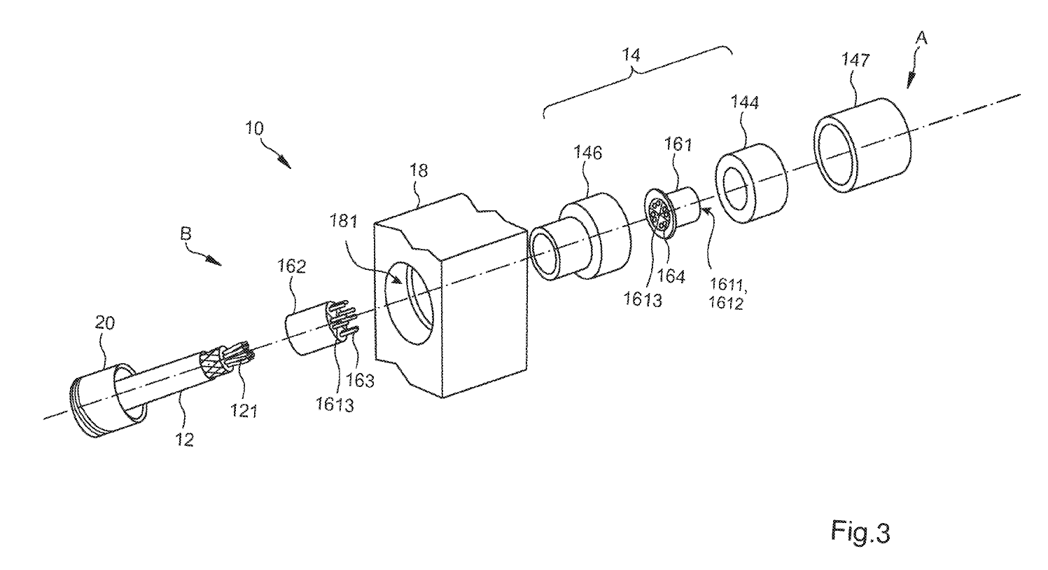

Housing 14 of data bus connector 10 can be designed to be single component or multi component. Housing 14 may for example be in the embodiment of a full metal housing, in particular with a plated surface. Housing 14 may be permanently mounted into electrocontact coupling 2, as described in further detail below with reference to FIG. 3.

On connector side A an insulating member 16 is located in housing 14. For clearer illustration of insulating member 16, housing 14 is opened along a dashed line C (FIG. 2).

Insulating member 16 includes an insulating member front part 161 and an insulating member rear part 162. Only a small section of insulating member rear part 162 is visible in FIG. 2. Not visible are conductors 163, 164 which are arranged in insulating member rear part 162, in order to provide an electrical connection between cable 12 and a female connector 1611 (in the case of socket 10) or a plug 1612 (in the case of connector 10′). Conductors 163, 164 may be embedded into the material of insulating member 16 and are thus mechanically fastened and electrically insulated from one another. Insulating member rear part 162 can be mechanically connected with data cable 12, for example by a crimp or clamp connection.

Alternatively, a screw connection or a plug connection with a suitable plug could also be provided here. Individual braids 121 of cable 12 can respectively be electrically connected with an associated conductor 163, 164, for example by one of the aforementioned connections or by soldering or welding.

Insulating member front part 161 is mechanically connected in housing 14 with insulating member rear part 162 and can easily be replaced. Insulating member front part 161 may be configured as a wear part and can be replaced after a certain number of connection cycles (typically 5000 to 50,000).

At insulating member rear part 162, electric lines or conductors 163, 164 accept electrical signals brought in from cable 12 via eight individual lines (accordingly four pairs) and transfer them to a respective number of lines or conductors 163, 164 of insulating member front part 161. Between conductors 163 of insulating member rear part 162 and conductors 164 of insulating body front part 161 a plug connection may be provided which is described in further detail below with reference to FIG. 3.

In the variation designed as socket 10 (above in FIG. 1), conductors 162 on mating side A are designed as female sockets 1611. In the male variety (lower section in FIG. 1) as plug connectors 10′, plugs 1612 are located on insulating member front part 161′ which can be inserted into the corresponding female sockets 1611.

In insulating member rear part 162 and in insulating member front part 161 all individual lines or individual conductors 163, 164 respectively are shielded in pairs of two. In insulating member front part 161 or on insulating member rear part 162 electrical shielding elements 1613 are provided for shielding of two pairs from one another. Said shielding elements 1613 can include for example a sheet metal, a metal mesh or a metal foil. In FIGS. 2 and 3, shielding elements 1613 viewed from the mating side, represent an X-shaped structure in whose four quadrants respectively one pair individual lines, one pair of female sockets 1611 or one pair of plugs 1612 are located.

Insulating member front part 161 or insulating member rear part 162 can be integrated with at least one shielding element 1613 and/or at least one conductor 163, 164. For this purpose, conductive elements 1613, 163, 164 can be inserted into recesses in insulating member front part 161 or insulating member rear part 162 which are intended for this, or conductive elements 1613, 163, 164 can be surrounded by a cast or sprayed thermosetting or curing insulating material.

In other embodiments, lines or conductors 163, 164 respectively, can be encased in pairs in suitable shielding. Moreover, shielding elements 1613 do not have to be designed on a continuous level. Rather, a suitable number of individual elements such as wires, powder-like metal particles or other conductive shielding elements may also be provided. The shielding elements can be embedded into the material of insulating member 16 or can be applied onto a surface, for example as a coating in order to provide the intended shielding function. For example, insulating body 161, 162 could respectively consist of four individual elements onto whose contact surfaces an electrically shielding coating could applied and which subsequently would be assembled into insulating members 161, 162.

In FIG. 2, the housing 14 includes a recess 141 located on the mating side of data bus connector 10 which corresponds with a nose-like structure 142′ of male plug 10′ and which ensures alignment of both connectors 10, 10′ during the connecting process.

FIG. 3 is an exploded view of a data bus connector 10 in an additional embodiment. A longitudinal axis is indicated in a dash/dotted line. In FIG. 3, housing 14 is a two-part unit with two axially adjacent parts. A housing front part 144 serves to accommodate and support insulating member front part 161 and interacts with a housing rear part 146 which can be equipped to accommodate insulating member rear part 162. For assembly of the plug connection, housing front part 144 with insulating member front part 161 and housing member rear part 146 with insulating member 162 are inserted into a contact support 18, or respectively into a recess 181 provided therein. Insulating member front part 161 can be designed male or female.

Contact support 18 can for example be a block consisting of an insulating material or also of a conductive material. A groove-pin combination or another suitable geometric structure on contact support 18 on housing 14 can ensure a reproducible alignment. In particular, an anti-rotation device can be provided to ensure a predetermined rotatory alignment of housing 14.

In one embodiment, recess 181 includes a stepped bore with one larger bore, one smaller bore and one radial step between the bores. The bores may be aligned concentrically, and the larger bore is may be located on mating side A. In FIG. 3, the larger bore is located on the right in a non-visible section of contact support 18. Housing 14, in particular housing rear part 146 can have a step-cylindrical outer contour with a smaller outside diameter and a larger outside diameter and a radial step that conforms to stepped bore 181. The radial fit of housing rear part 146 can be determined by fit of the larger outside diameter in the larger bore or the smaller outside diameter in the smaller bore. The axial fit may be defined by axial fit of the radial step of housing 14 against the step of stepped bore 181.

A screw element 147 can form a screw connection with contact support 18 in order to ensure a firm fit of housing parts 144, 146. Screw element 147 can be installed from connector side A and is equipped to press housing 14 axially into recess 181. Screw element 147 may have a continuous axial recess into which plug connection 10 or the other plug connection 10 can extend. In one embodiment, screw element 147 is furnished with an outside thread. A corresponding inside thread is provided on contact support 18, for example in the region of the larger bore. Screw element 147 can be in the embodiment of a banjo bolt or threaded coupling. In another embodiment, screw element 147 is equipped with an inside thread and a corresponding structure with a corresponding outside thread is provided on contact support 18. In this embodiment, screw element 147 can be a nut, in particular a cap nut. Screw element 147 can have one or several indentations on its axial side for engagement with an assembly tool. In regard to the nut, screw element 147 can in particular be a face nut.

On connection side B, individual braids 121 of cable 12 may be inserted into suitable receptacles of insulating member rear part 162 and brought in contact electrically and mechanically with respectively one conductor 163. For this purpose, braids 121 can be provided with suitable sockets or pins in a crimp connection. Insulating member rear part 162 can for example be axially secured in contact support 18 by a nut (not illustrated) or through another suitable connection technology. Insulating member rear part 162 is optionally also encased with an additional shield.

To assembly plug connection 10, insulating member rear part 162 is pushed axially into contact support 18 from connection side B, and housing 14 is pushed from mating side A axially into contact support 18 where they are respectively secured. In FIG. 3, an optional screw connection 20 is provided for securing insulating member rear part 162. Conductors in insulating member rear part 162 form herein electrical connections with conductors in insulating member front part 161 so that always one braid 121 of cable 12 is electrically connected with one conductor that is provided on connector side A for contact with the other plug-in connection and is insulated from the other conductors.

In FIG. 3, a conductor in the insulating member rear part includes a contact pin 163 and a conductor in insulating member front part 61 includes a corresponding contact socket 164, wherein contact pin 163 can be inserted into contact socket 164 in order to realize a plug-in connection. A reverse arrangement of contact pin 163 and contact socket 164 is also possible. The electrical connection of contacts 163, 164 can be produced herein through contact of contact pin 163 against contact socket 164 in radial direction, for example by clamping fit or a radially acting elastic element. In another embodiment, the electrical connection is produced by axial contact of the two conductors 163, 164, wherein at least one of the conductors 163,164 associated with the connection can be axially flexibly mounted. An axially flexible contact pin 163 that can be used for this purpose is known under the name “Pogo Pin”.

Insulating member front part 161 and insulating member rear part 163 respectively can be equipped with an, anti-rotation device in order to ensure that during assembly only conductors 163, 164 that are allocated to one another produce an electrical contact or an electrical connection.

Data bus connector 10 can have an additional plug-in connection on connection side B. In the current example an M12-connector with an X-coding is illustrated, however other embodiments are also possible. This embodiment represents a particular convenience during installation of data bus connector 10. A Gbit-data cable, for example a data bus cable routed through the rail car and already available can be simply contacted via the standardized M12-connector. This eliminates mechanical work when connecting the line during assembly. Alternatively to the plug-in connection, a permanently connected defined cable length or a preassembled connection of data bus cable 12 can be attached on housing 14.

In all cases a consistent shielding connection of data bus cable 12 on housing 14 and on shielding surfaces in insulating member 16 may be implemented. In other words, if possible all conductors in the embodiment of shielding elements are connected with one another and/or with a grounding potential or reference potential.

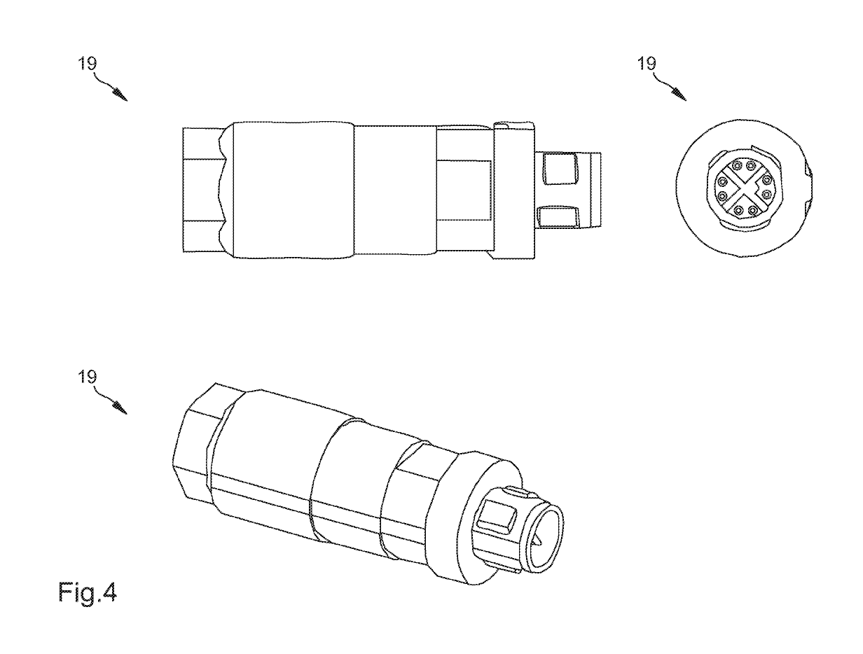

FIG. 4 shows three views of an exemplary cable connector 19 that can be attached to cable 12 and to which a corresponding receptacle on connection side B of connector 10 in one of the previous figures can be provided. The illustrated cable connector 19 is X-coded and in its illustrated design and configuration is similar to connector 10 in FIG. 3. In particular, the arrangement of conductors that can engage with conductors 163 in insulating member rear part 162, and that of a shielding element that can make contact with shielding element 1613 is herein designed accordingly.

Illustrated cable connector 19 has socket-type (female) contacts for engagement with pin-shaped (male) contacts 163 of insulating member rear part 162. In another embodiment, conductors 163 on connector 10 can also be socket-shaped. The contacts of the illustrated cable connector 19 are then pin-shaped.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION

2 Electrocontact coupling
3 first rail vehicle or train part
4 second rail vehicle or train part
5 mechanical train coupling
10 Plug, data bus connector, plug-in connection; also socket, socket connector
12 cable, data cable
121 braid
14 housing
141 recess
142 nose-shaped structure
144 housing front part
146 housing rear part
147 screw element
16 insulating member
161 insulating member front part
162 insulating member rear part
163 first conductor, first line, contact pin
164 second conductor, second line, contact socket
1611 female socket
1612 plug
1613 shielding element
18 contact support
181 recess
19 cable connector
A connector side
B connecting side

What is claimed is:

1. A plug connection for transmittal of electrical signals, comprising:
a housing; and
an insulating member arranged inside the housing and having a plurality of conductors which are insulated from one another, the insulating member including an insulating member front part and an insulating member rear part, the insulating member front part being configured for connecting mechanically with an insulating front part of another plug connection, at least one of the plurality of conductors on the insulating member front part being configured for electrically connecting to a cable, and at least one of the plurality of conductors between the insulating member rear part and the insulating member front part forming a detachable electrical connection therebetween.

2. The plug connection according to claim 1, wherein the detachable electrical connection is formed through an axial contact between at least two of the plurality of conductors.

3. The plug connection according to claim 1, wherein the detachable electrical connection is formed by a non-axial contact element.

4. The plug connection according to claim 1, wherein the housing includes a housing rear part and a housing front part that is detachable from same, and wherein the insulating member front part is removable from the insulating member rear part when the housing front part is separated from the housing rear part.

5. The plug connection according to claim 4, wherein the housing rear part is equipped to be inserted into a stepped bore, wherein a plug connection includes a screw element with a thread providing a screw connection with the stepped bore in order to press the housing front part against the housing rear part.

6. The plug connection according to claim 1, wherein the housing is a full metal housing.

7. The plug connection according to claim 1, wherein the insulating member front part and the insulating member rear part respectively include an electrically conductive shielding element which shields a first group of conductors from a second group of conductors, and wherein the electrically conductive shielding element of the insulating member front part and the electrically conductive shielding element of the insulating member rear part together form the detachable electrical connection.

8. The plug connection according to claim 7, wherein a plurality of electrically conductive shielding elements are provided on the insulating member front part or the insulating member rear part to respectively shield a first conductor from a second conductor in a pair from each other.

9. The plug connection according to claim 1, wherein the housing includes a contact lamella for electrical shield connectivity.

10. The plug connection according to claim 1, wherein the insulating member rear part includes a plug, on its side facing away from the insulating member front part, for contact with at least one of the plurality of conductors that are routed inside the insulating member.

11. An automatic electrical coupling device for installation in a rail-based vehicle, comprising:
a plug connection for transmittal of electrical signals, including:
a housing; and
an insulating member arranged inside the housing and having a plurality of conductors which are insulated from one another, the insulating member including an insulating member front part and an insulating member rear part, the insulating member front part configured for connecting mechanically with an insulating front part of another plug connection, at least one of the plurality of conductors on the insulating member front part configured for electrically connecting to a cable, and at least one of the plurality of conductors between insulating member rear part and insulating member front part forming a detachable electrical connection therebetween.

12. The automatic electrical coupling device according to claim 11, including a contact support with a recess in which the plug connection is accommodated, at least over a section of its extension in a longitudinal direction.

13. The automatic electrical coupling device according to claim 11, wherein the plug connection is arranged in such a way that the rail-based vehicle is maneuverable.
